(19) United States
(12) Patent Application Publication
(10) Pub. No.: US 2012/0274648 A1
(43) Pub. Date: Nov. 1, 2012

(54) MEMORY-EFFECT DISPLAY DEVICE AND DRIVING METHOD THEREOF

(75) Inventors: Hyun Ha Hwang, Seoul (KR); Seung Gon Kang, Hwaseong-si (KR); Heon Kyu Kim, Suwon-si (KR)

(73) Assignee: INTELLECTUAL DISCOVERY CO., LTD., Seoul (KR)

(21) Appl. No.: 13/459,655

(22) Filed: Apr. 30, 2012

(30) Foreign Application Priority Data
Apr. 29, 2011 (KR) 10-2011-0040561

(51) Int. Cl. G06F 3/038; G09G 5/36

(52) U.S. Cl. 345/545; 345/204

(57) ABSTRACT

There is provided a memory-effect display device including a memory-effect display, a data buffer unit that stores input data to be displayed on the memory-effect display, a buffer control unit that controls only some scan line data of input data of each frame to be stored in the data buffer unit, and a display control unit that controls the input data stored in the data buffer unit to be displayed at respective scan lines of the memory-effect display, wherein the display control unit controls only the some scan line data on the memory-effect display according to information of scan lines where the input data stored in the data buffer unit are to be assigned, and scan lines where the some scan line data are not assigned are maintained as they were displayed based on frame data before frame data containing the some scan line data are input.

### CROSS-REFERENCE TO RELATED APPLICATION

This application claims the benefit of Korean Patent Application No. 10-2011-0040561 filed on Apr. 29, 2011, the entire disclosure of which is incorporated herein by reference.

### TECHNICAL FIELD

The present disclosure relates to a memory-effect display device and a driving method thereof. More specifically, the present disclosure relates to a memory-effect display device of a video display performance enhanced by a driving method using a memory effect of the memory-effect display device and also relates to such a driving method.

### BACKGROUND

Recently, electronic books and electronic billboards using various types of electronic paper display have attracted a lot of attention. Such electronic paper is driven mainly in a reflection mode, and, thus, it is possible to reduce eye strain and minimize power consumption. However, electronic paper known so far has a slow response speed as compared with other display devices. Therefore, it has been known that the electronic paper has difficulty in displaying videos.

The electronic paper has been manufactured to be driven by, for example, an electrophoresis method using electronic ink distributed in micro capsules or micro cups, a QR-LPD method using dry movement of micro powder, a cholesteric liquid crystal display method, an electronicwetting method, and an electrochromic method. However, there has not been developed electronic paper having a very quick response speed.

### SUMMARY

In view of the foregoing, illustrative embodiments provide a memory-effect display device of an enhanced video display performance. In this regard, the present disclosure is provided to improve a video display method by suggesting an optimum driving method that supplements a response speed of electronic paper.

Further, the illustrative embodiments provide a driving method of the memory-effect display device of an enhanced video display performance.

In accordance with a first aspect of the illustrative embodiments, there is provided a memory-effect display device including a memory-effect display, a data buffer unit that stores input data to be displayed on the memory-effect display, a buffer control unit that controls a portion of scan line data of input data of each frame to be stored in the data buffer unit, and a display control unit that controls the input data stored in the data buffer unit to be displayed at respective scan lines of the memory-effect display, wherein the display control unit controls only the some scan line data on the memory-effect display according to information of scan lines where the input data stored in the data buffer unit are to be assigned, and scan lines of the memory-effect display where the some scan line data are not assigned are maintained as they were displayed based on frame data before frame data containing the some scan line data are input.

In accordance with a second aspect of the illustrative embodiments, there is provided a driving method of a memory-effect display device, the driving method including (a) displaying image data on the memory-effect display device based on first frame data, and (b) displaying scan line data of a first group among all scan line data of second frame data at respective scan lines of the memory-effect display device when the second frame data input subsequently to the first frame data are input, wherein in (b) the displaying scan line data, the scan lines which are not displaying the scan line data of the first group are maintained as they were displayed in (a) the displaying image data.

In accordance with a third aspect of the illustrative embodiments, there is provided a driving method of a memory-effect display device, the driving method including (a) displaying display target frame data on the memory-effect display device, and (b) displaying predetermined scan line data of a first group among the display target frame data at respective scan lines of the memory-effect display device, wherein scan lines where the scan line data of the first group are not assigned are maintained as they are displayed before (b) the displaying predetermined scan line data image data due to a memory effect of the memory-effect display device.

In accordance with a fourth aspect of the illustrative embodiments, there is provided a driving method of a memory-effect display device, the driving method including extracting scan line data of first to Nth groups from first frame data to Nth frame data which are input sequentially and displaying the extracted scan line data on the memory-effect display device, wherein the scan line data are assigned to predetermined scan lines, scan lines where the scan line data of respective groups are assigned are different from one another, and scan line data of the Nth group are displayed together with scan line data of the first to N−1th groups.

In accordance with the illustrative embodiments, it is possible to enhance a video display performance of a display device, such as electronic paper, having a low response speed. In particular, it is possible to enhance a quality of videos just by changing a driving method without changing a structure of electronic paper. Therefore, the illustrative embodiments can be applied to electronic paper driven by an electrophoresis method and other electronic paper driven by using various mediums to enhance a video display performance thereof.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is provided to explain a video display method of a typical display device;

FIGS. 2a and 2b are provided to explain a video display method of a typical electronic paper display device;

FIG. 3 is provided to explain an electronic paper display device in accordance with an illustrative embodiment;

FIGS. 4a and 4b illustrate a driving method of a memory-effect display device in accordance with an illustrative embodiment;

FIG. 5 is a flowchart showing a driving method of a memory-effect display device in accordance with an illustrative embodiment; and

FIG. 6 is provided to explain a result of performing a driving method of a memory-effect display device in accordance with an illustrative embodiment.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the terms “connected to” or “coupled to” that is used to designate a connection or coupling of one element to another element includes both a case that an element is “directly connected or coupled to” another element and a case that an element is “electronically connected or coupled to” another element via still another element. Further, the terms “comprises or includes” and/or “comprising or including” used in the document means that one or more other components, steps, operation and/or existence or addition of elements are not excluded in addition to the described components, steps, operation and/or elements unless context dictates otherwise.

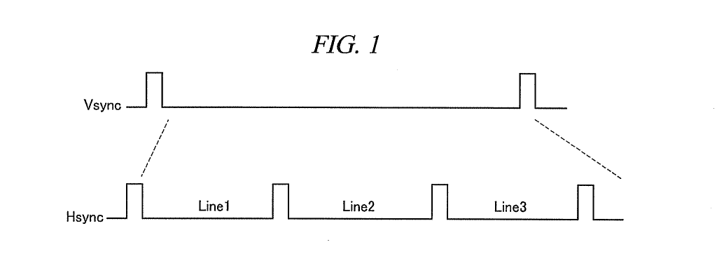

FIG. 1 is provided to explain a video display method of a typical display device.

NTSC or PAL standard video signals or VESA standard signals can be displayed by synchronizing such signals with VSYNC (vertical synchronization signal) and HSYNC (horizontal synchronization signal) and driving a display panel. That is, after a Vsync signal as a starting signal of a frame is generated, Hsync signals as signals of respective horizontal lines are generated in sequence.

At this time, generally, a frequency of the Vsync signal is about 50 Hz or about 60 Hz. That is, a display pixel is displayed about 50 times or about 60 times per second and an image seems to be moved due to a human eyes' afterimage effect. A CRT display or other LCD displays having a quick response speed can display videos according to the above-described method.

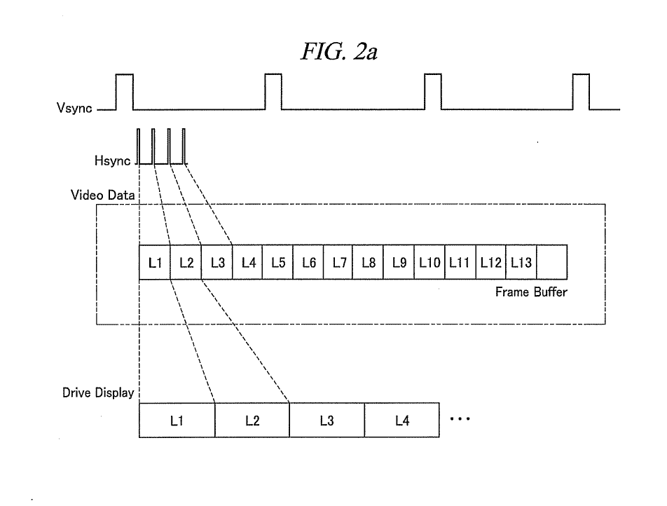

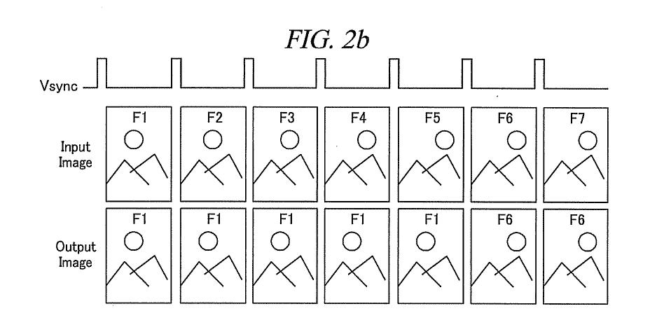

FIGS. 2a and 2b are provided to explain a video display method of a typical electronic paper display device.

By way of example, if an electronic paper display device is driven by a PM (passive matrix) method, a response speed of the electronic paper display device is slower than a synchronization signal of an image signal. Therefore, after image data of a frame are stored in a frame buffer, image data of each line are displayed.

A relationship between the response speed of the electronic paper display device and the synchronization signal will be explained in detail as follows. By way of example, as for a VGA 640×480 standard signal of about 60 Hz, a Vsync signal has a frequency of about 60 Hz, and, thus, it is generated about every 16.6 ms and a Hsync signal is generated at a period of about 34 us (about 16.6 ms/480). That is, an input signal can be synchronized with the Vsync signal and the Hsync signal by driving a line at a period of about 34 us to display videos. However, a response speed of a typical electronic paper display device is slower than this example device. If the electronic paper display device has a response speed of about 170 us which is about five times a generation signal of the Hsync signal, data of a first frame are displayed and then data of a sixth input frame are displayed.

As depicted in FIG. 2b, even if a plurality of input images F1 to F7 is input in sequence, the electronic paper display device outputs a first input image F1 and then outputs a sixth input image F6 but cannot output image frames therebetween. Therefore, quality of the resultant video is deteriorated.

A frame buffer having a capacity approximately equal to a size of an image is needed. By way of example, a XGA image needs a frame buffer of about 1024×768×3 (R, G, B) bytes.

In view of the foregoing, the present disclosure provides a new driving method to enhance a video display performance of an electronic paper display device.

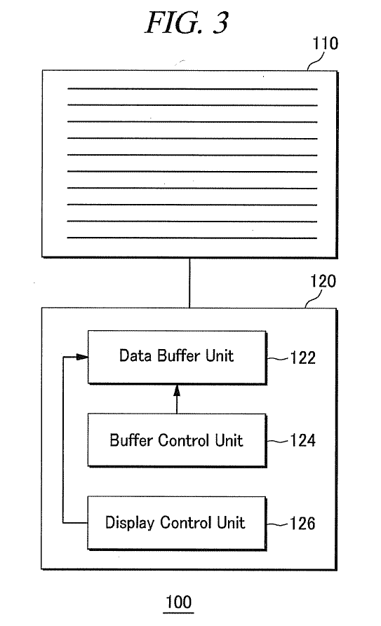

FIG. 3 is provided to explain an electronic paper display device in accordance with an illustrative embodiment.

An electronic paper display device 100 includes a memory-effect display 110 and a driving unit 120.

The memory-effect display 110 is a generally known electronic paper medium. Due to its bistability, the memory-effect display 110 can maintain a display state for a certain time without external power supply. The electronic paper medium includes electronic paper driven by an electrophoresis method using electronic ink distributed in micro capsules or micro cups, a QR-LPD method using dry movement of micro powder, a cholesteric liquid crystal display method, an electronicwetting method or an electrochromic method and may include other display mediums having bistability.

The driving unit 120 includes a data buffer unit 122, a buffer control unit 124, and a display control unit 126 and may include various other attachments for driving the memory-effect display 110.

The data buffer unit 122 stores a part of image data input from the outside. The stored data are transmitted to the memory-effect display 110 to be displayed. By way of example, image data of each frame are input and a part of the image data are stored. This can be applied to both an AM (active matrix) driving method and a PM (passive matrix) driving method which are generally used. That is, this can be applied to all kinds of driving methods capable of processing data in the form of scan line data as a part of frame data.

The buffer control unit 124 controls a part of the input image data to be stored in the data buffer unit 122. In a typical display device, input image data are transmitted directly to the data buffer unit 122 so as to smoothly display a video. However, electronic paper has a response speed slower than the typical display device. Thus, if all input image data are transmitted to a display, it is difficult to display a video.

Therefore, in accordance with the present illustrative embodiment, by using a memory effect of the memory-effect display 110, while already displayed data are maintained, a portion of the data is updated. In order to do so, a portion of the input image data is stored in the data buffer unit 122. The other portion of data is discarded so as not to be stored in the data buffer unit 122. More details will be explained later with reference to the accompanying drawings.

The display control unit 126 controls each of the input data to be displayed at each scan line according to information of scan lines where the input data stored in the data buffer unit 122 are to be assigned. By way of example, if input data stored in the data buffer unit 122 is to be assigned to an ith scan line, the display control unit 125 controls the data to be displayed at the ith scan line of the memory-effect display 110.

Hereinafter, an operation will be explained in detail with reference to the accompanying drawings.

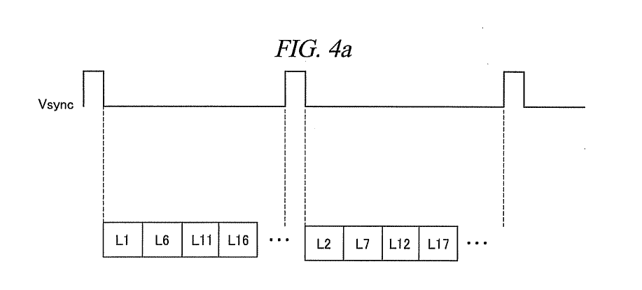

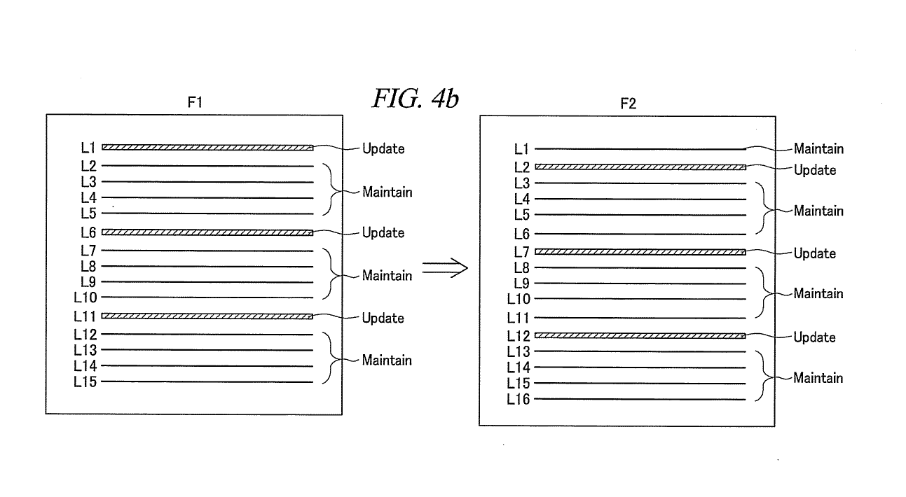

FIGS. 4a and 4b illustrate a driving method of a memory-effect display device in accordance with an illustrative embodiment.

As depicted in FIG. 4a, a memory-effect display device is driven so as to update only some scan line data of all scan line data constituting frame data in a section where a Vsync signal is activated. Non-updated scan line data are maintained as they were displayed due to a memory-effect of the memory-effect display device.

The some scan line data are determined depending on a response of the memory-effect display 110. By way of example, the some scan line data are determined depending on a time for displaying unit scan line data at a unit scan line of the memory-effect display 110 and a standard driving time of a unit scan line for displaying a video. Herein, the standard driving time is a maximum time to be assigned to drive a scan line for displaying a video of about 50 Hz or about 60 Hz. That is, if the time for displaying the unit scan line data at the unit scan line of the memory-effect display 110 is about N times of a standard driving time of a unit scan line of a typical display device, the number of scan lines to be updated is determined based thereon.

FIG. 4b illustrates a case where the N is 5. Scan lines to be updated are classified by a result of dividing the number of all scan lines by 5. That is, when first frame data F1 are input, scan line data L1, L6, L11 of a first group are displayed on the memory-effect display 110. At this time, the other scan lines are maintained as they were displayed before the first frame data F1 are input. Due to a property of the memory-effect display 110, it is possible to maintain an original state without applying a driving voltage to the memory-effect display 110.

Then, when second frame data F2 are input, scan line data L2, L7, L12 . . . of a second group are displayed on the memory-effect display 110. At this time, the other scan lines are maintained as they were displayed before the second frame data F2 are input. In particular, scan lines among the first group of the first frame data F1 are activated before the second frame data are input. Therefore, a display state of the memory-effect display 110 can be maintained better depending on a response speed of the memory-effect display 110.

Frame data to be input subsequently are processed in the same manner as described above. By way of example, when third frame data F3 are input, scan line data L3, L8, L13 . . . of a third group are displayed on the memory-effect display 110. At this time, the other scan lines are maintained as they were displayed before the third frame data F3 are input. Further, when fourth frame data F4 are input, scan line data L4, L9, L14 . . . of a fourth group are displayed on the memory-effect display 110. At this time, the other scan lines are maintained as they were displayed before the fourth frame data F4 are input. Likewise, when fifth frame data F5 are input, scan line data L5, L10, L15 . . . of a fifth group are displayed on the memory-effect display 110. At this time, the other scan lines are maintained as they were displayed before the fifth frame data F5 are input. By processing the first to fifth frame data as described above, when the fifth frame data are processed, the scan line data of the first to fifth groups are displayed together on a screen.

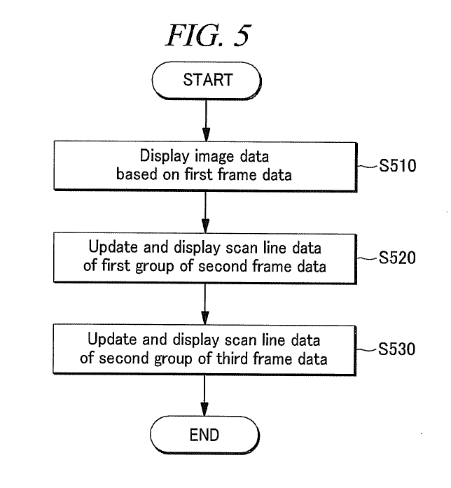

FIG. 5 is a flowchart showing a driving method of a memory-effect display device in accordance with an illustrative embodiment.

Based on first frame data, image data are displayed on the memory-effect display 110 (S510).

Then, scan line data of a first group of second frame data are updated and displayed on the memory-effect display 110 (S520). The second frame data are input subsequently to the first frame data. In order to do so, the buffer control unit 124 controls the scan line data of the first group to be stored in sequence in the data buffer unit 122. The other scan lines corresponding to non-updated data are maintained as they were displayed due to a memory effect of the memory-effect display 110.

Thereafter, scan line data of a second group among third frame data are updated and displayed on the memory-effect display 110 (S530). The third frame data are input subsequently to the second frame data. In order to do so, the buffer control unit 124 controls the scan line data of the second group to be stored in sequence in the data buffer unit 122. At this time, scan lines where the scan line data of the second group are assigned are not overlapped with scan lines where the scan line data of the first group are assigned. Although the scan lines where the scan line data of the first group are assigned may be configured so as to be adjacent to the scan lines where the scan line data of the second group are assigned, its configuration is not limited thereto and can be varied depending on a user's choice. The other scan lines corresponding to non-updated data are maintained as they were displayed due to a memory effect of the memory-effect display 110.

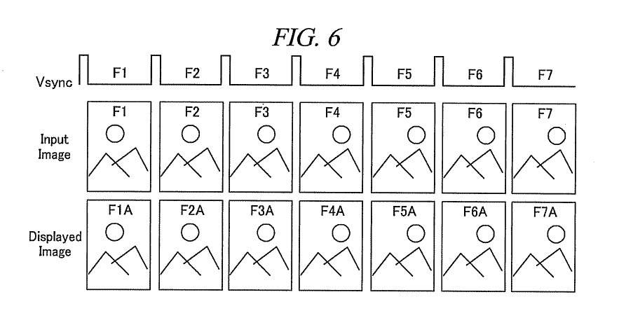

FIG. 6 is provided to explain a result of performing a driving method of a memory-effect display device in accordance with an illustrative embodiment.

Unlike the case as depicted in FIG. 2b, some scan line data from each of frame data are updated continuously. Therefore, a video can be displayed more smoothly. By updating and displaying the some scan line data from each of frame data as described above, it is possible to solve a problem occurring when the memory-effect display 110 displays videos.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A memory-effect display device comprising:
a memory-effect display;
a data buffer unit that stores input data to be displayed on the memory-effect display;
a buffer control unit that controls a portion of scan line data of input data of each frame to be stored in the data buffer unit; and
a display control unit that controls the input data stored in the data buffer unit to be displayed at respective scan lines of the memory-effect display,
wherein the display control unit controls only the portion of scan line data on the memory-effect display according to information of scan lines where the input data stored in the data buffer unit are to be assigned, and
scan lines of the memory-effect display where the some scan line data are not assigned are maintained as they were displayed based on frame data before frame data containing the some scan line data are input.

2. The memory-effect display device of claim 1,
wherein the data buffer unit stores the input data as a unit of the scan line data.

3. The memory-effect display device of claim 1,
wherein the buffer control unit stores scan line data of a first group of first frame data in the data buffer unit in sequence and stores scan line data of a second group of second frame data input subsequently to the first frame data in the data buffer unit in sequence, and
scan lines where the scan line data of the second group are assigned are not overlapped with scan lines where the scan line data of the first group are assigned.

4. The memory-effect display device of claim 3,
wherein the number of the scan lines where the scan line data of the first group are assigned is equal to the number of the scan lines where the scan line data of the second group are assigned.

5. The memory-effect display device of claim 3,
wherein the scan lines where the scan line data of the first group are assigned are adjacent to the scan lines where the scan line data of the second group are assigned.

6. The memory-effect display device of claim 3,
wherein the number of the scan lines where the scan line data of the first group are assigned is equal to a result of dividing a total number of scan lines of the memory-effect display device by N (N is a natural number of two or more), and
between the scan lines where the scan line data of the first group are assigned, scan lines in the number of (N−1) where the scan line data of the first group are not assigned are arranged.

7. The memory-effect display device of claim 6,
wherein the N is determined depending on a response speed of the memory-effect display and determined depending on a time for displaying unit scan line data at a unit scan line of the memory-effect display and a driving time of a unit scan line for displaying a standard video.

8. A driving method of a memory-effect display device, the driving method comprising:
(a) displaying image data on the memory-effect display device based on first frame data; and
(b) displaying scan line data of a first group among all scan line data of second frame data at respective scan lines of the memory-effect display device when the second frame data input subsequently to the first frame data, are input,
wherein in (b) the displaying scan line data, the scan lines which are not displaying the scan line data of the first group are maintained as they were displayed in (a) the displaying image data.

9. The driving method of claim 8, further comprising:
(c) displaying scan line data of a second group among all scan line data of third frame data on the memory-effect display device when the third frame data input subsequently to the second frame data are input,
wherein scan lines where the scan line data of the second group are assigned are not overlapped with scan lines where the scan line data of the first group are assigned.

10. The driving method of claim 9,
wherein the number of the scan lines where the scan line data of the first group are assigned is equal to the number of the scan lines where the scan line data of the second group are assigned.

11. The driving method of claim 9,
wherein the scan lines where the scan line data of the first group are assigned are adjacent to the scan lines where the scan line data of the second group are assigned.

12. The driving method of claim 8,
wherein the number of the scan lines where the scan line data of the first group are assigned is equal to a result of dividing a total number of scan lines of the memory-effect display device by N (N is a natural number of two or more), and
between the scan lines where the scan line data of the first group are assigned, scan lines in the number of (N−1) where the scan line data of the first group are not assigned are arranged.

13. The driving method of claim 12,
wherein the N is determined depending on a response speed of the memory-effect display and determined depending on a time for displaying unit scan line data at a unit scan line of the memory-effect display and a driving time of a unit scan line for displaying a standard video.

14. A driving method of a memory-effect display device, the driving method comprising:
(a) displaying display target frame data on the memory-effect display device; and
(b) displaying predetermined scan line data of a first group among the display target frame data at respective scan lines of the memory-effect display device,
wherein scan lines where the scan line data of the first group are not assigned are maintained as they are displayed before (b) the displaying predetermined scan line data due to a memory effect of the memory-effect display device.

15. A driving method of a memory-effect display device, the driving method comprising:
extracting scan line data of first to Nth groups from first frame data to Nth frame data which are input sequentially and displaying the extracted scan line data on the memory-effect display device,
wherein the scan line data are assigned to predetermined scan lines,
scan lines where the scan line data of respective groups are assigned are different from one another, and
scan line data of the Nth group are displayed together with scan line data of the first to N−1th groups.

16. The driving method of claim 15,
wherein the numbers of the scan lines where the scan line data of the respective groups are assigned are equal to one another.
